(19) United States
(12) Patent Application Publication
(10) Pub. No.: US 2025/0164041 A1
(43) Pub. Date: May 22, 2025

(54) TUBING BUNDLE END SEAL

(71) Applicant: OBCORP, LLC, St. Louis, MO (US)

(72) Inventor: Aaron M. Allen, Godfrey, IL (US)

(21) Appl. No.: 18/949,467

(22) Filed: Nov. 15, 2024

Related U.S. Application Data
(60) Provisional application No. 63/600,325, filed on Nov. 17, 2023.
(60) Provisional application No. 63/600,344, filed on Nov. 17, 2023.

(51) Int. Cl. F16L 5/14

(52) U.S. Cl. CPC F16L 5/14

(57) ABSTRACT

A tubing bundle end seal, configured to be adaptable to a variety of tubing bundles, that can function at temperatures upwards of 1000° C. The end seal includes a tubular canister and a fitting plate attachable to an end of the canister. A variety of fitting plates can be manufactured to receive a variety of tube and tracer configurations, allowing facile on-site adaptation of the end seal to nearly any tubing bundle termination need. A heat-shrinkable tube at the other end of the canister provides a simplified seal with tubing bundles of various diameters and shapes. The design additionally incorporates materials with properties sufficient to render the end seal water-tight while keeping it thermally resilient.

### CROSS-REFERENCE TO RELATED APPLICATIONS

Priority is claimed to U.S. Provisional Patent Application Ser. No. 63/600,325, filed Nov. 17, 2023, and U.S. Provisional Application Ser. No. 63/600,344, filed Nov. 17, 2023, both of which are hereby incorporated by reference.

### BACKGROUND OF THE INVENTION

Tubing bundles are widely used for carrying fluids through a variety of environmental conditions. Tubing bundles comprise one or more tubes packaged in a weatherproof jacket. When the tubing bundle is used in environments that may be colder than the desired operating temperature of the fluid, insulation is provided between the jacket and the tube(s), and a heating element, such as an electrical tracer or a steam tracer line, may also be provided adjacent the tube(s) within the jacket and insulation. Commercial tubing bundles are described, for example, in O'Brien/Ametek “TRACEPAK Tubing Bundle,” brochure QLT-TPBR, Ametek, Inc., 20 Sep. 2017, and in nvent/Raychem “RTB Tubing Bundles Installation Guide,” brochure Raychem-IM-H55626-RTBtubingbundle-EN-1805, nVent Services GmbH, 2018.

Some applications of tubing bundles include impulse lines, sampling lines, and process lines. In some of these applications, one end of the tubing bundle terminates near a high temperature source, over 400° F. and sometimes as high as 1200° F. At these sustained temperatures, the commonly used end seals employed to seal the end of the tubing bundle are ineffective to protect the bundle, especially, but not exclusively, the electrical tracing element which is subject to damage at these temperatures.

A typical high temperature application is shown in FIG. 1, in which a process fluid, such as high pressure steam, carried in a process line 30 is in fluid communication with an instrument 50 through a tubing bundle 70. In this illustrative application, the instrument 50 is a pressure transmitter 51, and the tubing bundle 70 includes one or more tubes 71 filled with liquid water. The tubing bundle includes an electrical tracer 73 designed to keep the tube(s) 71 in a narrow temperature band within a range of 50° F. to 250° F.

The transmitter 51 is typically mounted in an insulated container 53. The container 53 typically is connected to a power supply 55 which powers the instrument 51. The insulated container 53 frequently contains an electrical heating element 57 connected to the power supply 55 to protect the instrument 51 from freezing or to maintain an operating temperature for the instrument 51. A distal end of the tubing bundle 70 generally enters the insulated container 53 through a gland 59, and all fluid connections to the instrument 50 and electrical connections to the transmitter 51 and power supply 55 are made inside the insulated container 53. Inside the container 53, tube(s) 71 and tracer 73 are brought out of the tubing bundle 70 by cutting away and removing a jacket 75 and insulation 77. The exposed tube(s) 71 is/are connected to the transmitter 51 and optionally to other instruments within the container 53. The electric tracer 73 is connected to the power supply 55. These connections are well known in the art and do not in themselves form a part of the present invention.

The process line 30 is typically of large diameter, such as a two-foot diameter pipe, and the process fluid in the pipe is typically at a high temperature over 400° F., sometimes over 1000° F. A common application is in an electric power plant where the process line 30 carries high pressure steam at a temperature of around 1,000° F. to 1,200° F.

At a proximal end of the tubing bundle 70, tube(s) 71 and tracer 73, in the tubing bundle 70 are brought out of the tubing bundle 70 by cutting away and removing the jacket 75 and insulation 77. The exposed tube(s) 71 is/are connected to the process line 30 through valves 31 and 33 in series. The electric tracer 73 would be damaged by sustained contact with the valves 31 and 33 or any other surface over about 350° F. It therefore is terminated in accordance with local codes, such as by looping it back and capping it in a junction box 79 attached to the tubing bundle 70.

Because of the high temperature of the fluid (steam) flowing through the tubes, a simple silicone seal or heat shrink boot cannot be used for protecting the cut proximal end of the tubing bundle 70. Instead, to protect the exposed proximal end of the tubing bundle 70 and to meet local codes, the open end of the tubing bundle 70 is closed with a high temperature end seal kit 80.

A current state-of-the-art end seal kit 80 includes a cast cup 81 having fittings in its closed end for tube(s) 71 and/or tracer 73. Detailed installation procedures for one such end seal kit are set out in “High Temperature End Seal Kit Selection Guide and Installation Instructions,” brochure QLT-HIGHTEMP-INST 2N, Ametek, Inc, 16 Sep. 2014. Instructions for a similar end seal kit are given in “FAK-7HTS High Temperature Tubing Bundle End Seal Kit-INSTALLATION PROCEDURES” (https://content.thermon.com/pdf/u_pdf_files/PN500028-FAK-7HTS-installation.pdf), Thermon, San Marcos, Texas.

It will be seen that these approaches to forming a high temperature termination for the tubing bundle suffer serious problems. The end seal kit 80 must be made to accommodate the diameter of the tubing bundle, the number and size of tube(s) 71 within the bundle, and the number and types of tracers 73, if any. This requires a large inventory of cups 81. Further, installing the cup 81 requires carefully sealing the open end of the cup to the outer surface of the tubing bundle, either by wrapping tape around them or by stuffing the gap between the cup and the tubing bundle, generally both. Moreover, feeding the tube(s) 71 and tracer 73 through the fittings on the cup 81 is tedious at best and may result in damage to the tubes or tracer. The skill and care required of the installer make installation time-consuming and unreliable.

### BRIEF SUMMARY

The present invention provides a high temperature tubing bundle end seal assembly that produces one or more of the advantages of ease of installation, reduction in expensive inventory, and superior reliability.

In accordance with an embodiment of the invention, an end seal for a tubing bundle includes a canister having an opening at a first end for the tubing bundle and a fitting plate at a second end, the fitting plate having at least one tube fitting sized to form a seal with a tube carried by the tubing bundle. In embodiments, the canister is tubular, although other cross-sections are possible. In embodiments, the first end of the canister comprises a sleeve connector having an outwardly protruding neck forming the opening at the first end of the canister. In embodiments, sleeve connector is a separate piece attached to the first end of the canister. In embodiments, the fitting plate is generally planar and is secured to the canister by screws. In embodiments, holes such as round holes or keyholes for the screws are provided in the fitting plate. In other embodiments, the fitting plate is generally planar and is held to the canister by a threaded ring in the manner of a Mason jar lid. In embodiments, the fitting plate is sealed to the second end of the canister by a separate gasket. In other embodiments, the gasket is bonded to the fitting plate. In other embodiments, the fitting plate is sealed to the canister by an O-ring. In embodiments, the fitting plate is provided with openings, and threaded fittings are held in the openings by nuts.

In accordance with an embodiment of the invention, an end seal for a tubing bundle includes a canister having a sleeve connector at a first end, the sleeve connector having an outwardly protruding neck forming an opening for the tubing bundle to enter the canister, and a polymeric sleeve adhered to the protruding neck, the sleeve being shrinkable by the application of radiation to form a seal with the tubing bundle. In an embodiment, the radiation is heat. In an embodiment, the sleeve comprises a heat-activated adhesive on its inner surface to adhere the sleeve to the neck and to the tubing bundle. In an embodiment, the heat-shrinkable sleeve has a shrink ratio of at least 3:1, preferably at least 4:1.

In an embodiment, the sleeve connector is secured to the canister and the sleeve is adhered to the neck of the sleeve connector before it is shipped as a canister assembly to a job site. The canister assembly is slipped over the tubing bundle, and, when the canister assembly is in a desired position on the tubing bundle, the sleeve is shrunk over and adhered to the tubing bundle.

In accordance with an embodiment of the invention, a method of providing a high temperature end seal for a tubing bundle includes slipping a canister over an end of the tubing bundle with a second end of the canister facing the end of the tubing bundle, extending a tube from the tubing bundle through a fitting in a fitting plate, thereafter attaching the fitting plate to the canister, and thereafter sealing a first end of the canister to the tubing bundle. In an embodiment, the first end of the canister is sealed to the tubing bundle by a heat-shrinkable polymeric sleeve.

It will be seen that a single version of the present high temperature end seal can serve the needs of a wide range of tubing arrangements, tube sizes, bundle sizes, and the presence or absence of electrical tracer elements, by employing a selected fitting plate specific thereto. The novel design additionally incorporates materials with properties sufficient to form a water-tight seal at both ends of the canister.

In an illustrative embodiment, the tubing bundle end seal assembly comprises a radially-shrinkable polymeric sleeve, a sleeve connector, a metal canister (preferably provided with external cooling fins), a fitting plate selected from a plurality of fitting plates, and tube and/or tracer fittings selected from a variety of tube and tracer fittings. The polymeric sleeve is configured to form a secure seal around a tubing bundle, at a first end, and around a sleeve connector at a second end. The polymeric sleeve is compressed around the differing radii of the tubing bundle and sleeve connector (for example by application of heat) to provide a flexible waterproof seal around both. The sleeve connector is configured to be affixed to a first end of a generally cylindrical, metal canister which preferably can withstand high temperatures. The opposing second end of the canister is configured to receive one of a variety of fitting plates. These fitting plates each define one or more openings configured to receive tube fittings or tracer fittings. Via this embodiment, a tubing bundle extends through the polymeric sleeve connector and into the canister. The polymeric sleeve creates a seal around the junction of the tubing bundle and the sleeve connector. The components of the tubing bundle then proceed through the canister to be received by, and pass through, the one or more tube or tracer fittings in the fitting plate and can then be routed to other destinations as various end user applications require. The complete, secure nature of affixation of each of the elements of the tubing bundle end seal is such that the assembly remains waterproof and resilient to extreme temperatures for the length of the tubing bundle's passage.

### BRIEF DESCRIPTION OF THE SEVERAL VIEWS OF THE DRAWINGS

FIG. 1 is a view in perspective of a known high temperature application in which the present invention is useful.

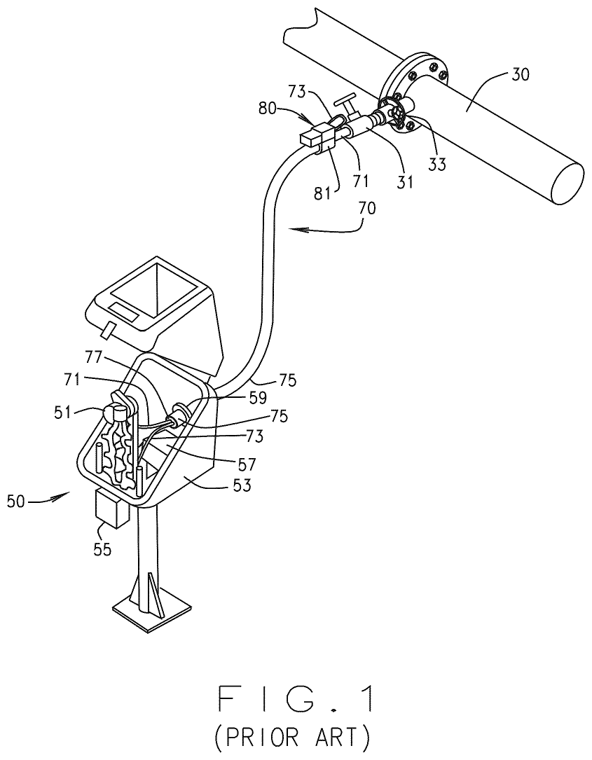

FIG. 2 is a view in perspective, of an illustrative embodiment of end seal assembly of the invention, attached to a tubing bundle;

FIG. 3 is a view in perspective, corresponding to FIG. 2, of the end seal assembly of FIG. 2 in the process of being installed;

FIG. 4 is an exploded side view of the end seal assembly of FIGS. 2 and 3;

FIGS. 5A-C are end views of alternative configurations of fitting plates for use in the end seal assembly of FIGS. 2-4; and

FIG. 6 is an exploded view in perspective of the end seal assembly of FIGS. 2-4, with a different fitting plate.

Corresponding reference numerals will be used throughout the several figures of the drawings.

### DETAILED DESCRIPTION

The following detailed description illustrates the claimed invention by way of example and not by way of limitation. This description will clearly enable one skilled in the art to make and use the claimed invention, and describes several embodiments, adaptations, variations, alternatives and uses of the claimed invention, including what is presently believe is the best mode of carrying out the claimed invention. Additionally, it is to be understood that the claimed invention is not limited in its application to the details of construction and the arrangements of components set forth in the following description or illustrated in the drawings. The claimed invention is capable of other embodiments and of being practiced or being carried out in various ways. Also, it is to be understood that the phraseology and terminology used herein is for the purpose of description and should not be regarded as limiting.

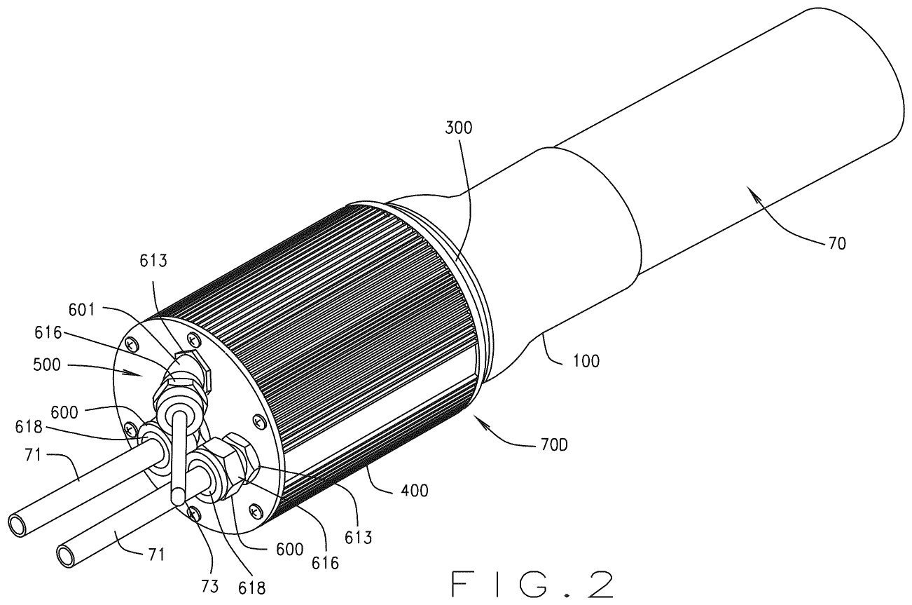

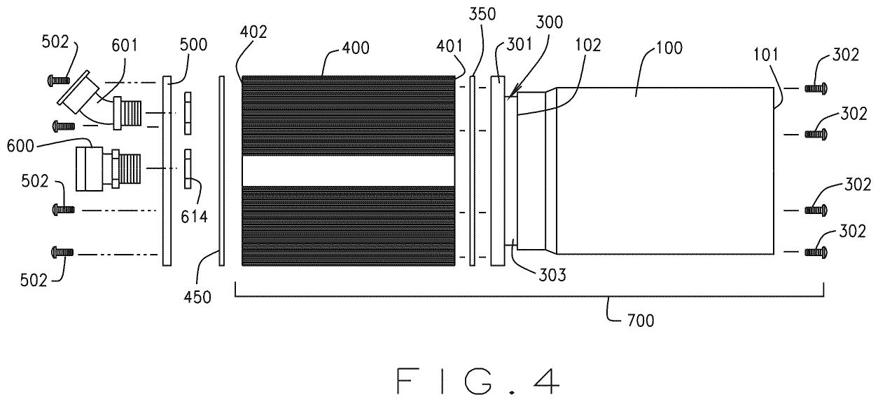

Referring now to FIGS. 2-6, an illustrative tubing bundle end seal assembly 10 is designed to provide an easy-to-install, water-tight end seal in a high-temperature environment. The end seal assembly 10 comprises a central canister 400, a sleeve connector 300 sized to receive the tubing bundle, a heat shrinkable, flexible sleeve 100 attached to the sleeve connector 300, and a fitting plate 500 that can be affixed to the canister. The fitting plate 500 is selected from a plurality of fitting plates containing varying arrangements of tubing and tracer fittings 600 and 601, respectively, to accommodate tubing bundles containing various numbers and arrangements of tubing and tracers.

The canister 400 is appropriately sized to accommodate a tubing bundle of any common size, while leaving an air gap around the tubing bundle. The illustrative embodiment described will accommodate tubing bundles having diameters from about 1″ to about 4″.

The canister 400 comprises a wall 400a having a plurality of axially extending internal ribs 410 which, as shown in the drawings, extend the length of the wall. These ribs are shaped so as to define passages 420 that, in the illustrative embodiments of FIGS. 2-6, receive fasteners 302 and 502, as described below. Illustratively, the outer surface of the wall comprises a plurality of axially extending ridges or flutes which strengthen the canister 400 and act as cooling fins.

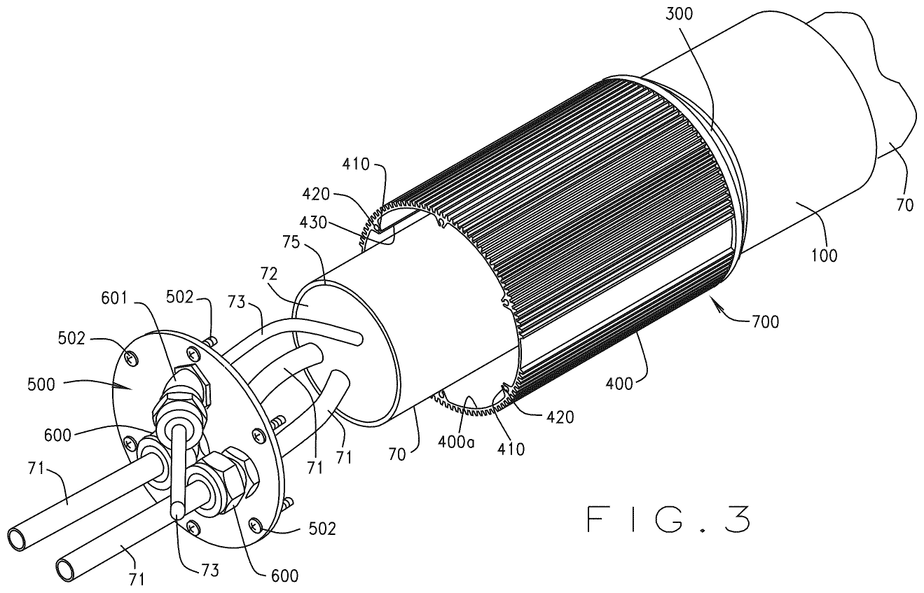

The canister 400 is illustratively formed by extrusion, and the ribs 410 with their internal passage 420 are thus generally “C” shaped. As shown in FIG. 3, these ribs define an elongate slot 430 extending axially the length of the rib and opening into the passage 420 of the rib. In this illustrative embodiment, six ribs 410 are regularly spaced around the interior of the canister wall 400a.

The canister 400 is formed from a material that can withstand high temperatures, such as temperatures above 250° F., above 300° F., above 400° F., above 500° F., above 750° F., or above 1000° F. In this illustrative embodiment, the high temperature canister material comprises 6061 aluminum, which, after being cut, has undergone two-step anodization.

Desirably, the canister 400 is of fixed diameter and length regardless of the arrangement and dimensions of the tubing bundle to be received by the canister. Having a single size of canister reduces the need to stock multiple size canisters. The canister has an inner diameter sufficient to enable the tubes of the tubing bundle to be separated within the canister. In this illustrative example, the length of the canister is about 6.0 inches, the outer diameter of the canister is about 5.125 inches, and the inner diameter of the canister is about 4.8 inches. This size of a canister has been found to be sufficient for most tubing bundles.

The sleeve connector 300 is secured to a first end 401 of the canister. The sleeve connector includes a flange 301 and a neck 303 extending from the flange. The flange 301 defines a plurality of holes 305 which are positioned to be aligned with the passages 420 of the canister. Fasteners 302, in the form of self-tapping stainless steel head screws, pass through the holes 305 of the flange 301 into the passages 420 of the canister ribs 410 to secure the sleeve connector to the canister. As seen in the figures, the flange 301 has an outer diameter substantially equal to the outer diameter of the canister, and the neck 303 has a diameter slightly smaller than the outer diameter of the canister. The neck diameter is sized to permit passage of a tubing bundle and to receive the heat shrinkable sleeve 100 on its exterior surface. Illustratively, the neck 303 has an inner diameter of 4.0″ and an outer diameter of 4.25″.

In the illustrative embodiment, the sleeve connector 300 is made of a thermoplastic polyoxymethylene, illustratively a Delrin® acetal plastic.

The illustrative end seal assembly 10 includes a first gasket 350 positioned between the canister 400 and flange 301 of the sleeve connector 300 in order to form a better seal between the two components. In the illustrative embodiment, the gasket 350 comprises a room temperature vulcanizable (RTV) silicone applied around the face of the flange 301 before the canister 400 is secured to the sleeve connector 300.

The radially-shrinkable polymeric sleeve 100 has first and second longitudinal ends 101 and 102. Heat shrinkable polymer sleeves are well known, and heat shrinkable sleeves having heat shrink ratios of 3:1 or greater will accommodate a wide range of tubing bundle sizes. Ratios of 4:1 or greater are preferred. In the illustrative embodiment, the sleeve is formed from a polyolefin polymer with a shrink ratio of 4:1 and a continuous use temperature rating up to 135° C. In preferred embodiments, the inner surface of the sleeve 100 is provided with an adhesive that melts and flows when heated. Such adhesive-lined heat-shrinkable sleeves are well known. A modified amide adhesive is one useable example. Illustratively, the sleeve 100 has an expanded inner diameter of 4.25″ and a length of 6.75″.

The second longitudinal end 102 of the sleeve 100 fits about the neck 303 of the sleeve connector and is shrunk to create a seal around the neck of the sleeve connector. When the sleeve 100 is shrunk, the adhesive on its inner surface melts and flows, encapsulating and sealing it to the neck 303 of the sleeve connector 300, forming a water-tight insulating seal with the neck 303 of the sleeve connector 300. The sleeve 100 (prior to shrinking) can have an expanded inner diameter greater than the outer diameter of the cylindrical neck 301 of the sleeve connector 300; for example, the sleeve can have a diameter that is about 0.25 inch greater than the diameter of the sleeve connector neck. The neck 301 may also include a step forming a stop for the sleeve 100; as can be appreciated, this facilitates positioning of the heat shrink sleeve about the neck 301 of the sleeve connector 300.

Illustratively, the sleeve 100 is attached to the sleeve connector 300, and the sleeve connector 300 is attached to the canister 400 at the factory before they are shipped as a canister assembly 700 to a job site. It will be seen that the canister assembly 700 is a universal assembly, useable with tubing bundles from 1″ to 4″ in diameter and with any configuration of tubing and tracers within the tubing bundle.

A circular fitting plate 500 is secured to the second end 402 of the canister 400 opposite the sleeve connector 300. The illustrative fitting plate 500 is made of stainless steel. The illustrative fitting plate 500 is a generally flat plate having a diameter generally equal to the outer diameter of the canister. The fitting plate defines a plurality of holes 501 positioned about the plate's circumference. These holes 501 are positioned on the fitting plate to align with the passages 402 of the canister ribs when the fitting plate is positioned on the canister. The fitting plate can thus be secured to the canister by means of stainless steel self-tapping screws 502 that pass through the fitting plate holes 501 and into the rib passages 402.

The fitting plate 500 defines one or more openings 510, each of which receives a tube fitting 600 or tracer fitting 601. The fittings 600 and 601 comprise a threaded neck 612 sized to pass through an opening 510 in the fitting plate and be secured by, for example, an integral hex head 613 on a first side of the fitting plate 500 and a lock nut 614 on the opposite side of the fitting plate. The fittings 600 and 601 illustratively comprise a neoprene grommet 618 through which tubing or tracers extend and a tightening member 616, wherein rotation of the tightening member 616 forces the grommet 618 into a water-tight sealing arrangement with the tube or tracer passing through the fitting 600 or 601, respectively. The fittings 600 and 601 can be zinc electroplated to be corrosion resistant.

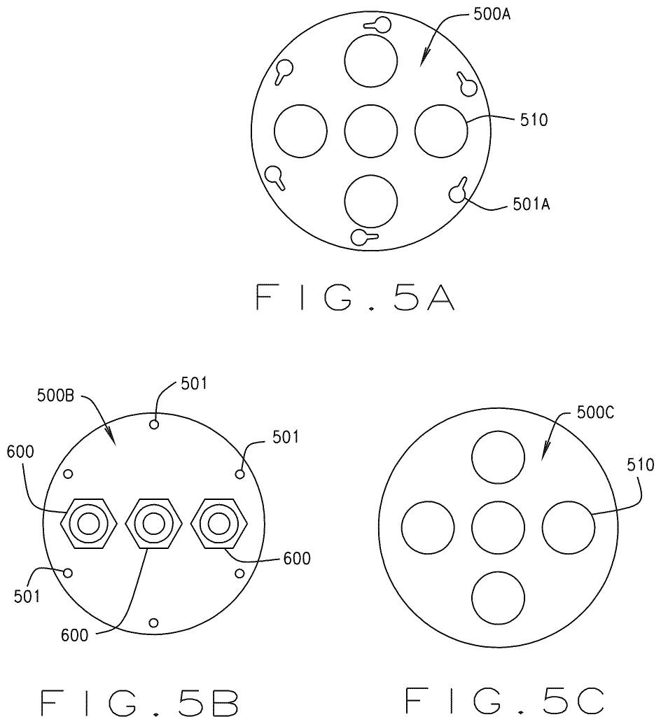

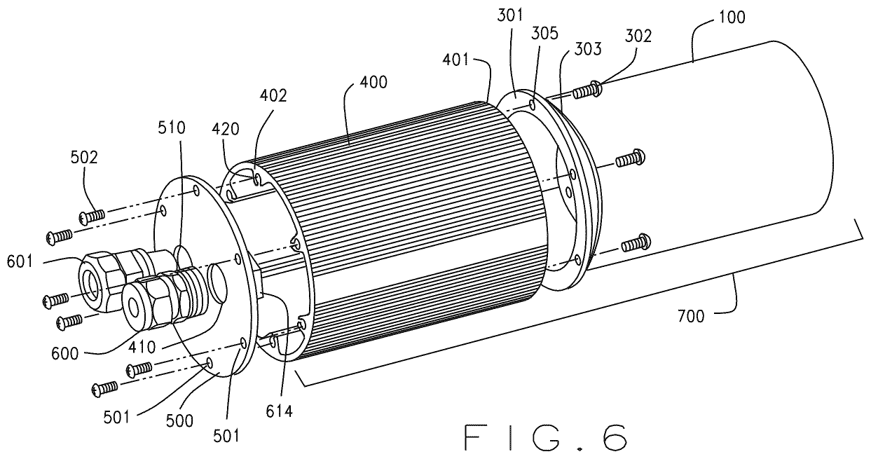

FIG. 6, FIGS. 5B and 2-4, and FIGS. 5A and 5C show illustrative versions of fitting plates with two, three, and five fittings, respectively, and with the fittings arranged in a row (FIGS. 5B and 6), a triangle (FIGS. 2-4), and a “+” configuration (FIGS. 5A and 5C), but these are non-limiting embodiments, as the number, size, and arrangement of fittings may foreseeably vary according to the end user's application. Suitable fittings are well known, an example being RACO Series 3702, Hubbell Incorporated, Shelton, Connecticut.

A second, annular, gasket 450 is positioned between the canister 400 and the circular fitting plate 500 in order to form a better seal between the two components. The gasket 450 may be formed of the same materials as the gasket 350. In the illustrative embodiment, the gasket 450 comprises a room temperature vulcanizable (RTV) silicone applied around the periphery of an inner face of the circular fitting plate 500 before the canister 400 is secured to the fitting plate 500.

In order to assemble the end seal assembly 10, the canister assembly 700 including sleeve 100, sleeve connector 300, and canister 400 is positioned on a tubing bundle 200 with a length of the tubing bundle 200 extending beyond the open end 402 of the canister 400, as shown in FIG. 3. At a distance a few inches greater than the length of the longest desired free tube length extending from the end seal assembly 10, the outer jacket 75 and insulation 77 of the tubing bundle 70 are cut away and removed, exposing the tube(s) 71 and tracer(s) 73.

As shown in FIG. 3, a plate 500 having the appropriate number and placement of openings 510 is chosen, and the appropriate fittings 600 and 601 are tightened into the openings 510 with lock nuts 614, leaving the tightening members (compression fittings) 616 untightened. The free tube(s) 71 and tracer(s) 73 are then bent as needed and passed through the fittings 600 and extended the desired distance beyond the plate 500. The length of exposed tube(s) 71 on the canister side of the plate 500 is less than the length of the canister 400. The tightening members 616 are then tightened onto the tube(s) 71 and any tracer(s) 73 to form water-tight seals. An RTV silicone sealant is applied around the periphery of the face of the plate 500 facing the end 402 of the canister 400 to form the gasket 450. The canister assembly 700 is then slid into engagement with the plate 500, and the plate 500 is attached with screws 502. Finally, a heat gun is employed to apply heat to the sleeve 100, shrinking and adhering it to the jacket 75 of the tubing bundle 70, thereby forming a water-tight seal with the tubing bundle 70.

It will be appreciated that the order of tightening the sealing members 616 and attaching the plate 500 will likely vary with particular situations, and that partial tightening of the members 616 or of the screws 502 may be preferred in some situations before all of the elements are finally tightened. Heat shrinking the sleeve 100 to bond the end seal 10 to the tubing bundle 100 will usually be the last step in the installation method, but in some situations it may be desirable to attach the canister assembly 700 to the tubing bundle before the end seal is completely installed.

It will be seen that because any required bending of tube(s) 71 and tracer(s) 73 and threading them through fittings 600 takes place outside the canister 400, this operation is far simpler than in prior art systems. Further, the method of installation and the oversized diameter of the canister 400 simplify terminating a tracer 73 inside the canister 400 or wrapping a tracer around one or more exposed tube(s) 71 inside the canister. The method is also believed to make installation of the high temperature termination 10 both easier and more reliable than prior methods.

As can be appreciated, the end seal assembly 10 provides an end seal for a tubing bundle which will protect the tubing bundle from elevated temperatures, i.e., temperatures above 250° F., above 300° F., above 400° F., above 500° F., above 750° F., or, preferably, above 1000° F. (or more).

As noted above, the canister is preferably formed in just one length and diameter, the length and diameter being selected to be appropriate for a large number of applications (regardless of the number of tubes and tracers in the bundle 200). With the canister being of a single diameter and length, only one size of sleeve connector needs to be produced, and the number of fitting plates is reduced relative to what would be required if the canister were provided in multiple diameters.

Numerous variations in the tubing bundle end seal and method of the present invention, within the scope of the appended claims, will be apparent to those skilled in the art in light of the foregoing description of preferred embodiments of the invention.

As shown in FIG. 5A, the holes 501 in the fitting plate 500 may be keyhole shaped holes 501A, so that the screws 502 may be partially pre-installed in the passages 420 in the canister 400, the heads of the screws 502 passed through the enlarged portions of the holes 501A, the plate turned clockwise, and the screws 502 tightened. As shown in FIG. 5B, the fittings 600 and/or 601 may be pre-installed in the fitting plate 500. As shown in FIG. 5C, the fitting plate may be formed without holes 501 and secured to the canister 400 either by an adhesive sealant or by a threaded ring, like a Mason jar ring, screwed onto mating threads (not shown) formed in the exterior of second end 402 of the canister 400.

For further example, although the canister 400 is preferably provided as a single length, it could be formed as an extruded tube, which is then cut to the desired length for a particular application. The canister is preferably, but not essentially, tubular, but it need not be circular in cross-section. Because the canister 400 is freely rotatable on the tubing bundle before being attached to the fitting plate 500, attachments between these components requiring their relative rotation, such a screw threads or bayonet joints, may be substituted for screws 502. The fitting plate 500 may also be attached by bolts, clamps, latches, adhesive, or other conventional means.

The passages 420 can be threaded so as to receive threaded fasteners. The slots 430 are an artifact of the extrusion process, and one of ordinary skill in the art can envision passages with or without such slots or defined by slots or openings of varying width and angle. Although the ribs 410 are shown as extending axially along the entire length of the canister 400, they do not need to. The ribs need only extend inwardly from the end edges of the canister a distance sufficient to receive fasteners.

The canister can be formed from any suitable material, such as iron, iron alloys (including steels), nickel alloys, aluminum, copper, titanium, engineered materials, and other rigid and thermally stable materials known to those of ordinary skill in the art and which will withstand the environment to which they are subjected.

Any other desired connection, such as clamps, latches, adhesive, etc., could be used to secure the sleeve connector 300 to the canister, or the sleeve connector could be formed integrally with the canister 400.

The sleeve connector 300 may be made from metal, from ceramic, or from another polymer such as polyvinyl chloride (PVC), chlorinated polyvinyl chloride (CPVC), polyolefin, acrylonitrile butadiene styrene (ABS), polyvinylidene fluoride (PVDF), polytetrafluoroethylene (PTFE), nylon, or perfluoroalkoxy (PFA) polymers.

The gaskets 350 and 450 may be made of any suitable material, such as paper, rubber, silicone, metal, cork, felt, neoprene, nitrile, fiberglass, PTFE, a blend of aromatic polyamide fiber and nitrile rubber commonly known as “aramid/Buna-N,” or any other polymer components known to those of ordinary skill in the art that can withstand the environment to which they will be subjected. O-rings, adhesives, or other sealants may form the gaskets.

The sleeve 100 may be formed of other radiation-shrinkable materials, such as elastomeric polymers, fluorinated ethylene propylene, PVC, PVDF, silicone rubber, PTFE, or other fluorinated polymers.

These variations are merely illustrative.

All patents, patent applications, and literature mentioned herein are hereby incorporated by reference.

1. An end seal for a tubing bundle comprising a canister having an opening at a first end for the tubing bundle and a fitting plate at a second end, the fitting plate having at least one tube fitting sized to form a seal with a tube carried by the tubing bundle.

2. The end seal of claim 1 wherein the canister is tubular.

3. The end seal of claim 1 wherein the first end of the canister comprises a sleeve connector having an outwardly protruding neck forming the opening at the first end of the canister.

4. The end seal of claim 1 wherein the fitting plate is generally planar and is secured to the canister by screws.

5. The end seal of claim 1 wherein the fitting plate is provided with openings, and wherein threaded fittings are held in the openings by nuts.

6. An end seal for a tubing bundle comprising a canister having a sleeve connector at a first end, the sleeve connector having an outwardly protruding neck forming an opening for the tubing bundle to enter the canister, and a polymeric sleeve adhered to the protruding neck, the sleeve being shrinkable by the application of radiation to form a seal with the tubing bundle.

7. The end seal of claim 6 wherein the radiation is heat.

8. The end seal of claim 6 wherein the sleeve comprises a heat-activated adhesive on its inner surface to adhere the sleeve to the neck and to the tubing bundle.

9. The end seal of claim 6 wherein the sleeve has a shrink ratio of at least 4:1.

10. The end seal of claim 6 further comprising a fitting plate at a second end of the canister, the fitting plate having at least one tube fitting sized to form a seal with a tube carried in the tubing bundle.

11. The end seal of claim 10 wherein the fitting plate is secured to the second end of the canister with screws.

12. The end seal of claim 11 wherein the canister comprises internal axially-extending ribs holding the screws.

13. The end seal of claim 6 wherein the canister comprises external axially-extending cooling fins.

14. A method of assembling an end seal on a tubing bundle comprising at least one tube, the method comprising slipping a tubular canister onto an end of the tubing bundle, the canister having a first open end and a second open end, the second end of the canister facing the end of the tubing bundle, extending the tube from the tubing bundle through a fitting in a fitting plate, and thereafter attaching the fitting plate to the canister and sealing the first end of the canister to the tubing bundle.

15. The method of claim 14 wherein the first end of the canister is sealed to the tubing bundle by a heat-shrinkable polymeric sleeve.

16. The method of claim 15 wherein the sleeve is attached to the first end of the canister before the canister is slipped onto the tubing bundle.

17. An end seal kit adapted to be used with a plurality of tubing bundle sizes and a plurality of tubing bundle configurations, the kit comprising
a canister assembly comprising a tubular canister sized to fit a largest tubing bundle of a range of sizes of tubing bundles, a sleeve connector attached to a first end of the canister, and a heat shrinkable sleeve attached to the sleeve connector, the sleeve having an expanded diameter sufficient to accept the largest tubing bundle of the range of sizes of tubing bundles and having a shrink ratio of at least 3:1, and
a fitting plate sized and configured to be sealed to a second end of the canister, the fitting plate comprising at least one sealable opening sized to accept a tube from the tubing bundle.

18. The kit of claim 17 wherein the sleeve has a shrink ratio of at least 4:1.

19. The kit of claim 17 wherein the sleeve has an adhesive on its inner surface, the adhesive binding the sleeve to the sleeve adapter and forming a water-tight seal with the sleeve adapter.

20. The kit of claim 17 wherein the canister has axially-extending ribs, the sleeve connector being attached to the canister by screws extending into the ribs, the fitting plate comprising screw holes alignable with the ribs.
